(19) United States
(12) Patent Application Publication
(10) Pub. No.: US 2026/0340281 A1
(43) Pub. Date: Oct. 29, 2026

(54) METHOD FOR PARSING DOCUMENTS AND ELECTRONIC DEVICE SUPPORTING THE SAME

(71) Applicant: Sionic AI Inc., Seoul (KR)

(72) Inventors: Semin JEONG, Seoul (KR); Hyewon KIM, Seoul (KR); Dokyoon YOON, Seoul (KR); Hojin YANG, Seoul (KR); Woomyoung PARK, Seoul (KR)

(21) Appl. No.: 19/551,088

(22) Filed: Feb. 26, 2026

(30) Foreign Application Priority Data
Apr. 24, 2025 (KR) 10-2025-0053590

(51) Int. Cl. G06F 40/205; G06F 40/30

(52) U.S. Cl. CPC G06F 40/205; G06F 40/30

(57) ABSTRACT

A document parsing method executed by at least one processor, includes inputting a document to an artificial neural network-based parser, identifying, in the document, a first content of a first type and a second content of a second type different from the first type, parsing the first content to extract first data, converting the second content into natural language-based second data including semantic information of the second content based on a first context related to the second content, and generating a final parsing result of the document using the first data and the second data.

### CROSS-REFERENCE TO RELATED APPLICATION

This application claims priority to and the benefit of Korean Patent Application No. 10-2025-0053590, filed in the Korean Intellectual Property Office on Apr. 24, 2025, the entire contents of which are hereby incorporated by reference.

### TECHNICAL FIELD

The present disclosure relates to a document parsing method and an electronic device supporting the same.

### BACKGROUND

Corresponding to the advancement of digital convergence, in which various information and communication technologies are fused, electronic devices are providing various functions and/or services combined with their core functions. For example, an electronic device may operate a retrieval augmented generation (RAG) system that generates a response to a user prompt based on data retrieved from a database using a language model. This RAG system may involve a series of processes of parsing a document obtained from a local and/or various external sources of the electronic device to extract text, and embedding the text into a vector that the language model can understand and storing the vector in a database.

However, in the document parsing process, content of a type different from text, for example, a table and/or a figure included in the document, is not easily extracted by a parser, so a problem may occur in which data related to the content is lost. Alternatively, a solution is being considered to convert content of the table and/or figure type into structured data such as markdown, Hypertext Markup Language (HTML), and/or JavaScript Object Notation (JSON) to compensate for such parser defects, but the structured data may not reflect the structural information of the content (for example, the relationship between rows (row) and columns (column) of the table), or may reflect the structural information distortedly, so a problem may occur in which it is difficult for a language model to intuitively understand the structured data. These problems may degrade the performance of the language model that generates a response to a user prompt using data retrieved from the database.

The above-described content is provided as background art for the purpose of assisting in the understanding of the present disclosure, and no assertion or determination is raised as to whether the above-described content may be applied as prior art related to the present disclosure.

### SUMMARY

The present disclosure provides a document parsing method and an electronic device supporting the same for solving the above-described problems.

The technical problem to be solved by the present disclosure is not limited to the above-described content, and other problems not mentioned will be clearly understood by those skilled in the art from one or more example embodiments described herein.

The present disclosure may be implemented in various ways, including a method, an electronic device, and/or a computer program stored in a readable recording medium.

In some implementations, a document parsing method executed by at least one processor, the method may include inputting a document to an artificial neural network-based parser, identifying, in the document, a first content of a first type and a second content of a second type different from the first type, parsing the first content to extract first data, converting the second content into natural language-based second data including semantic information of the second content based on a first context related to the second content, and generating a final parsing result of the document using the first data and the second data.

In some implementations, the identifying the first content of the first type and the second content of the second type may include analyzing a layout of the document using the artificial neural network-based parser, and identifying at least one of a type of content, an attribute of content, or a position of content included in the document using the artificial neural network-based parser, based on the layout analysis.

In some implementations, the converting the second content into the natural language-based second data may include identifying at least a portion of the first content included within a designated distance range from position information corresponding to the second content in the document based on the position of the content.

In some implementations, the converting the second content into the natural language-based second data further may include identifying data related to at least one of a caption, a title, or a note related to the second content among at least a portion of the first data corresponding to the at least a portion of the first content using the artificial neural network-based parser, and determining the data related to the at least one of the caption, the title, or the note as the first context related to the second content.

In some implementations, the converting the second content into the natural language-based second data further may include generating a first portion of the natural language-based second data that describes data included in the second content using the artificial neural network-based parser, and generating a second portion of the natural language-based second data that defines the second content or further describes the data included in the second content using the artificial neural network-based parser, based on the data determined as the first context.

In some implementations, the converting the second content into the natural language-based second data further may include determining a precedence relationship between the first portion and the second portion of the second data using the artificial neural network-based parser, based on at least a portion of the first content corresponding to the data determined as the first context and a position of the second content, and arranging the first portion or the second portion to precede in the second data based on the precedence relationship.

In some implementations, the generating the final parsing result of the document may include determining a second context related to the second content using the artificial neural network-based parser, based on the position of the content.

In some implementations, the determining the second context may include identifying an arrangement relationship between the first content and the second content using the artificial neural network-based parser, based on the position of the content, determining a sequence for arranging the first data and the second data in the final parsing result based on the arrangement relationship, and determining the sequence as the second context related to the second content.

In some implementations, the generating the final parsing result of the document further may include generating the final parsing result as natural language-based data in which the first data and the second data are integrated using the artificial neural network-based parser, based on the sequence.

In some implementations, the inputting the document may include inputting the document including at least one of a word processor document, a spreadsheet document, a presentation document, a web document, or a Portable Document Format (PDF) document.

In some implementations, the identifying the first content of the first type and the second content of the second type may include identifying at least one of a table or a figure as the second content of the second type.

In some implementations, the document parsing method further includes storing the final parsing result in a vector database, receiving a prompt related to the second content, obtaining at least a portion of the second data related to the prompt from the vector database using a language model, and generating answer data for the prompt using the language model, based on the at least a portion of the second data.

In some implementations, the artificial neural network-based parser may include at least one of a vision language model, a multimodal language model, or an object detection model. The document parsing method may further include training the artificial neural network-based parser by inputting at least one parameter of the document and at least one parameter of the final parsing result into the artificial neural network-based parser, and outputting, based on the trained artificial neural network-based parser, a parsing result of a second document.

In some implementations, a non-transitory computer-readable storage medium having instructions stored thereon, the instructions, when executed by one or more processors, cause the one or more processors to perform the document parsing method.

In some implementations, a computer program stored in a computer-readable recording medium for executing, by a computer, the document parsing method may be provided.

In some implementations, an electronic device, may include a memory for storing instructions, and at least one processor, wherein the instructions, when executed by the at least one processor, cause the electronic device to input a document to an artificial neural network-based parser, identify, in the document, a first content of a first type and a second content of a second type different from the first type, parse the first content to extract first data, convert the second content into natural language-based second data including semantic information of the second content based on a first context related to the second content, and generate a final parsing result of the document using the first data and the second data.

According to one or more example embodiments of the present disclosure, a mechanism may be provided that is capable of converting content of a table and/or figure type included in a document into natural language-based data in a parsing process of the document, and generating a parsing result of the document using the data.

According to the example embodiment(s) of the present disclosure, loss and/or distortion of data for content of a table and/or figure type in the parsing process of the document may be minimized.

According to the example embodiment(s) of the present disclosure, response performance and/or response reliability of a language model for a user prompt related to content of a table and/or figure type may be improved.

The effects of the present disclosure are not limited to the effects mentioned above, and other effects not mentioned will be clearly understood by those skilled in the art from the description of the claims.

### BRIEF DESCRIPTION OF THE DRAWINGS

One or more example embodiments of the present disclosure will be described with reference to the following drawings, and in relation to the description of the drawings, the same or similar reference numerals may be assigned to the same or corresponding components.

FIG. 1 illustrates an electronic device in a network environment.

FIG. 2 illustrates a memory.

FIG. 3 illustrates a parsing process of an artificial neural network-based parser.

FIG. 4 illustrates a first content and second content identification process of an artificial neural network-based parser.

FIG. 5 illustrates an example of a process of converting a second content into natural language-based data of an artificial neural network-based parser.

FIG. 6 illustrates a process of storing a parsing result in a database.

FIG. 7 illustrates a response process of a language model to a user prompt related to a second content.

FIG. 8 illustrates a document parsing method.

### DETAILED DESCRIPTION

Hereinafter, specific details for implementing the present disclosure will be described in detail with reference to the accompanying drawings. However, in the following description, detailed descriptions of well-known functions or configurations will be omitted if it is determined that they may unnecessarily obscure the gist of the present disclosure.

In the accompanying drawings, the same or corresponding components are assigned the same reference numerals. In addition, in the description of the example embodiment(s) herein, redundant descriptions of the same or corresponding components may be omitted. However, even if the description of a component is omitted, it is not intended that such a component is not included in the present disclosure.

Advantages and features of the present disclosure and methods of achieving them will become clear with reference to the example embodiment(s) described herein in conjunction with the accompanying drawings. However, the present disclosure is not limited to the example embodiment(s) disclosed herein but may be implemented in various different forms, and these example embodiment(s) are provided only to make the present disclosure complete and to fully inform the person skilled in the art of the scope of the disclosure.

The terms used in the present disclosure will be briefly described, and the example embodiment(s) will be described in detail. The terms used in the present disclosure are general terms that are currently widely used as much as possible in consideration of the functions in the present disclosure, but this may change depending on the intention of those skilled in the relevant field, precedents, the emergence of new technologies, etc. In addition, in specific cases, there are terms arbitrarily selected by the applicant, and in this case, the meaning will be described in detail in the corresponding description part of the disclosure. Therefore, the terms used in the present disclosure should be defined based on the meaning of the terms and the overall content of the present disclosure, rather than simply the names of the terms.

In the present disclosure, singular expressions include plural expressions unless specifically stated otherwise in the context. In addition, plural expressions include singular expressions unless specifically stated otherwise in the context. Throughout the present disclosure, when a part is said to include a component, this means that the part may further include other components rather than excluding other components unless there is a specific description to the contrary.

The term ‘module’ or ‘unit’ used in the present disclosure means a software or hardware component, and the ‘module’ or ‘unit’ performs certain roles. However, the ‘module’ or ‘unit’ is not limited to software or hardware. The ‘module’ or ‘unit’ may be configured to be in an addressable storage medium or may be configured to play one or more processors. Accordingly, as an example, the ‘module’ or ‘unit’ may include at least one of software components, object-oriented software components, class components, and task components, and processes, functions, attributes, procedures, subroutines, segments of program code, drivers, firmware, microcode, circuits, data, databases, data structures, tables, arrays, or variables. The functions provided in the components and ‘modules’ or ‘units’ may be combined into a smaller number of components and ‘modules’ or ‘units’or further separated into additional components and ‘modules’ or ‘units’.

As used herein, a ‘module’ or ‘unit’ may be implemented as a processor and a memory. A ‘processor’ should be broadly interpreted to include a general-purpose processor, a central processing unit (CPU), a microprocessor, a digital signal processor (DSP), a controller, a microcontroller, a state machine, etc. In some circumstances, a ‘processor’ may also refer to an application-specific integrated circuit (ASIC), a programmable logic device (PLD), a field programmable gate array (FPGA), etc. A ‘processor’ may also refer to a combination of processing devices, for example, a combination of a DSP and a microprocessor, a combination of a plurality of microprocessors, a combination of one or more microprocessors coupled with a DSP core, or any other such configuration. In addition, ‘memory’ should be broadly interpreted to include any electronic component capable of storing electronic information. ‘Memory’ may refer to various types of processor-readable media, such as random access memory (RAM), read-only memory (ROM), non-volatile random access memory (NVRAM), programmable read-only memory (PROM), erasable-programmable read-only memory (EPROM), electrically erasable PROM (EEPROM), flash memory, magnetic or optical data storage, registers, etc. Memory is called to be in electronic communication with a processor if the processor can read information from and/or write information to the memory. Memory integrated into a processor is in electronic communication with the processor.

Terms such as first, second, A, B, (a), (b), etc., used in the present disclosure are used only to distinguish one component from another, and the essence, order, or sequence of the component is not limited by the term.

When it is described in the present disclosure that a component is ‘connected’, ‘coupled’, or ‘attached’ to another component, it should be understood that the component may be directly connected or attached to the other component, or indirectly with another component possibly ‘connected’, ‘coupled’, or ‘attached’ in between.

‘Includes’ and/or ‘including’ used in the present disclosure do not exclude the presence or addition of one or more other components, steps, operations, and/or elements to the mentioned components, steps, operations, and/or elements.

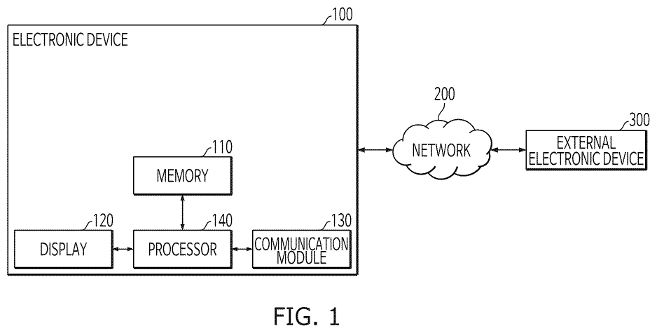

FIG. 1 illustrates an electronic device in a network environment.

Referring to FIG. 1, an electronic device 100 may include various types of devices capable of storing, providing, and executing computer-executable programs and data related to a data processing service (for example, a service of converting content of a table and/or figure type included in a document into natural language-based data that a language model 115 can understand, and generating a parsing result of the document using the data). For example, the electronic device 100 may include at least one of a system device, a server device, a distributed computing device based on a cloud service, or a mobile communication device.

The electronic device 100 may communicate with at least one external electronic device 300 through a network 200. For example, the electronic device 100 may be communicatively connected (or establish a communication channel) through the network 200 with the at least one external electronic device 300 that may provide various types of documents to the electronic device 100. The network 200 may be configured with a wired network including at least one of ethernet, power line communication, a telephone line communication device, or RS-serial communication, a wireless network including at least one of a mobile communication network, wireless LAN (WLAN), Wi-Fi, Bluetooth, or ZigBee, or a combination thereof, depending on the installation environment. A communication method between the electronic device 100 and the at least one external electronic device 300 is not limited, and may include not only a communication method utilizing a communication network that the network 200 may support (for example, a mobile communication network, wired Internet, wireless Internet, a broadcasting network, and/or a satellite network), but also a short-range wireless communication method between the electronic device 100 and the at least one external electronic device 300.

The electronic device 100 may include components related to the execution and/or provision of the data processing service. For example, the electronic device 100 may include a memory 110, a display 120, a communication module 130, and at least one processor 140. At least some of the components included in the electronic device 100 may be connected to each other via a bus, general purpose input and output (GPIO), serial peripheral interface (SPI), or mobile industry processor interface (MIPI) to exchange signals (for example, commands or data).

The memory 110 may include any computer-readable non-transitory recording medium. The memory 110 may include a permanent mass storage device such as read only memory (ROM), a disk drive, a solid state drive (SSD), and/or flash memory (flash memory). A non-volatile mass storage device such as ROM, SSD, flash memory, and/or a disk drive may be included in the electronic device 100 as a separate permanent storage device distinguished from the memory 110.

An operating system, at least one application program, and/or at least one program code may be stored in the memory 110. These software components may be loaded from a computer-readable recording medium separate from the memory 110. The recording medium may include a recording medium that can be directly connected to the electronic device 100, and may include, for example, a floppy drive, a disk, a tape, a DVD/CD-ROM drive, and/or a memory card. Alternatively, the software components may be loaded into the memory 110 through the communication module 130. For example, the at least one program may be loaded into the memory 110 based on a computer program installed by files provided by a file distribution system through the network 200.

The memory 110 may store instructions related to the functional operations of the components of the electronic device 100. For example, the memory 110 may store instructions that cause the components of the electronic device 100 to perform defined functional operations when executed by the at least one processor 140.

The display 120 may be at least partially exposed to the outside of the electronic device 100 to visually provide various types of content. For example, the display 120 may output (or display) an execution screen and/or a user interface of at least one application included in the electronic device 100. In relation to this, the display 120 may include a display driving integrated circuit that receives and processes a driving signal corresponding to video information from the at least one processor 140. In addition, the display 120 may include a touch panel (or, a touch sensing circuit), and may sense various types of user inputs based on the touch panel and output corresponding electrical signals.

The communication module 130 may provide a configuration or function for the electronic device 100 to communicate with the at least one external electronic device 300 through the network 200. For example, the communication module 130 may establish communication (or, a communication channel) with the at least one external electronic device 300 according to a defined communication protocol, and may perform transmission/reception of signals, data, and/or information through the communication. The communication module 130 may include a wireless communication module (for example, a cellular communication module, a short-range wireless communication module, and/or a global navigation satellite system (GNSS) communication module) and a wired communication module (for example, a local area network (LAN) communication module and/or a power line communication module). Such a wireless communication module and a wired communication module may be configured as separate chips from each other, or may be integrated into one chip.

The at least one processor 140 may be configured to process instructions of a computer program provided by the memory 110 and/or the communication module 130 by performing basic arithmetic, logic, and input/output operations. For example, the at least one processor 140 may be configured to execute instructions received according to program code stored in the memory 110 and/or instructions received from the at least one external electronic device 300 through the network 200. One or more example embodiments of the present disclosure described herein may be implemented by the at least one processor 140 executing instructions (or code) of a computer program.

The at least one processor 140 may be configured to execute an artificial neural network-based parser 111 for providing a data processing service. For example, the at least one processor 140 may execute the artificial neural network-based parser 111 by executing computer program code (or instructions) loaded into the memory 110. The at least one processor 140 may receive signals, data, and/or information transmitted from the at least one external electronic device 300 through the communication module 130 while executing the artificial neural network-based parser 111, and may process and store the signals, data, and/or information in the memory 110. In addition, the at least one processor 140 may store signals, data, and/or information generated while executing the artificial neural network-based parser 111 in the memory 110, or may transmit the signals, data, and/or information to the at least one external electronic device 300 through the communication module 130.

The electronic device 100 may additionally include other components in addition to the above-described components (for example, the memory 110, the display 120, the communication module 130, and the at least one processor 140).

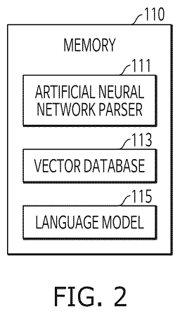

FIG. 2 illustrates a memory according to the present disclosure.

Referring to FIG. 2, the memory 110 of the electronic device 100 may include components that support the operation of a retrieval augmented generation (RAG) system of the electronic device 100. For example, the memory 110 may include an artificial neural network-based parser 111, a vector database 113, and the language model 115. The memory 110 of the electronic device 100 may further include other components in addition to the above-described components (for example, the artificial neural network-based parser 111, the vector database 113, and the language model 115). For example, the memory 110 of the electronic device 100 may further include a chunker or a text splitter (also referred to as a splitter) that chunks text data parsed by the artificial neural network-based parser 111 into units of words, sentences, paragraphs, documents, and/or a defined number of tokens. Also, for example, the memory 110 of the electronic device 100 may further include at least one embedding (embedding) model that represents the chunked text data as vectors.

The artificial neural network-based parser 111 may parse input data to obtain structured data. For example, the artificial neural network-based parser 111 may receive a document, parse content included in the document to extract text data, or convert content of a specific type into text data.

The database 113 may include a vector database specialized for storing and searching data in the form of high-dimensional vectors. For example, the database 113 may store text data generated by the artificial neural network-based parser 111 and vector data corresponding to the text data, and may support searching and providing text data having a high similarity with a prompt (or query) represented as a vector.

The language model 115 may generate and provide a response to a prompt (or query), and may use text data retrieved from the database 113 in the response generation process. The language model 115 may include at least one of a large language model or a small language model modeled based on an artificial neural network.

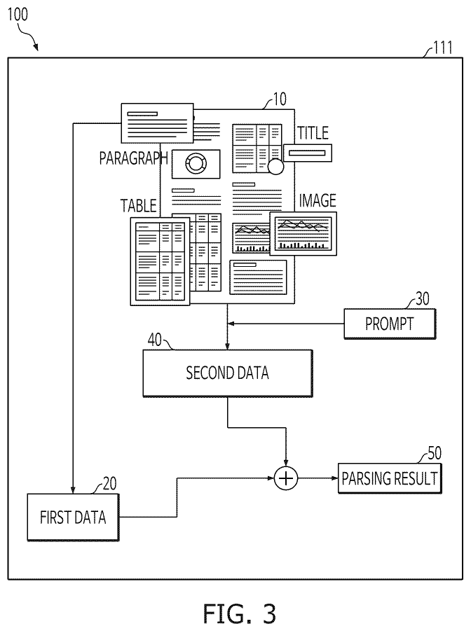

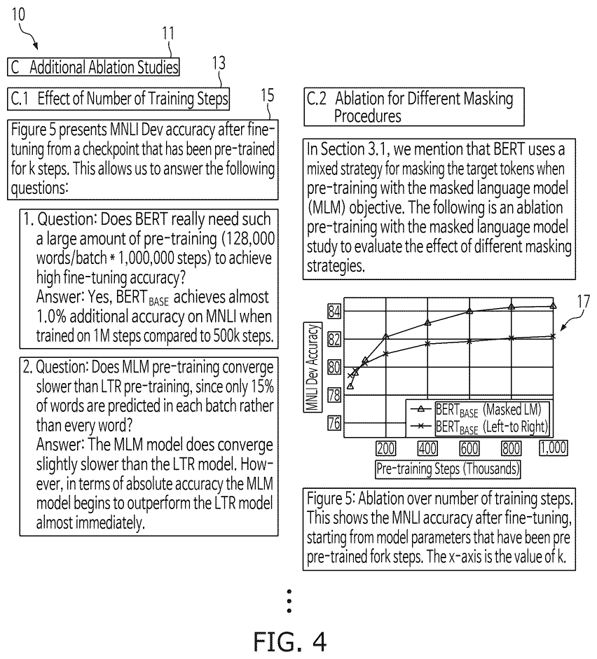

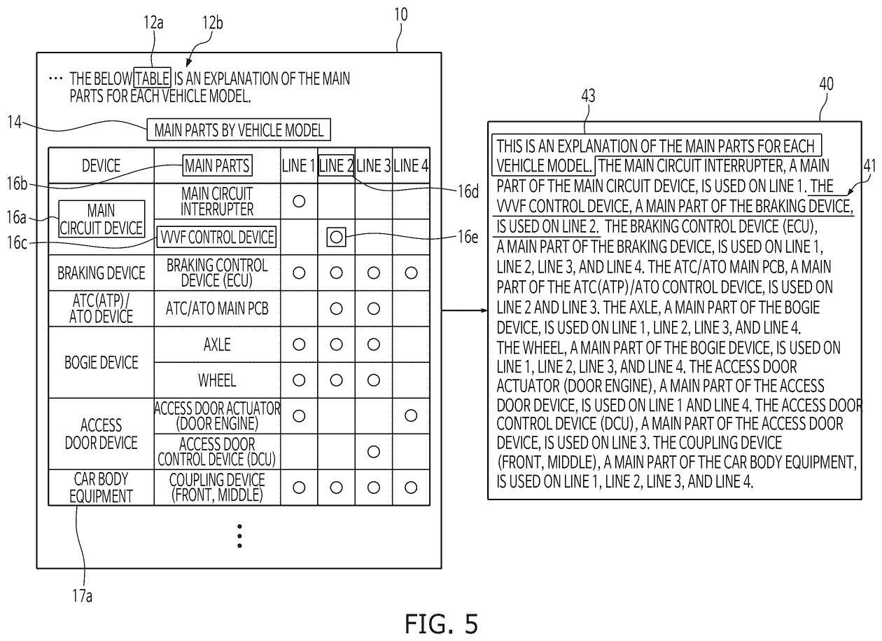

FIG. 3 illustrates a parsing process of an artificial neural network-based parser. FIG. 4 illustrates a first content and second content identification process of an artificial neural network-based parser. FIG. 5 illustrates an example of a process of converting a second content into natural language-based data of an artificial neural network-based parser.

Referring to FIGS. 3 and 4, the electronic device 100 may input a document 10 of various types loaded from the memory 110 or obtained from an external source (for example, the external electronic device 300) to the artificial neural network-based parser 111. For example, the electronic device 100 may input the document 10 including at least one of a word processor document in DOC and/or DOCX format (e.g., according to Word® Binary File Format of Microsoft Corporation® of Redmon, Washington), a spreadsheet document in XLS and/or XLSX format (e.g., according to Excel® Binary File Format of Microsoft Corporation® of Redmon, Washington), a presentation document in PPT and/or PPTX format (e.g., according to Power Point® Binary File Format of Microsoft Corporation® of Redmon, Washington), a web document in HTM and/or HTML format, or a PDF document to the artificial neural network-based parser 111 to parse the document 10. However, the document 10 input to the artificial neural network-based parser 111 in the present disclosure is not limited to the above-described formats. For example, as long as the document 10 includes content of a table and/or figure (figure) type, the document 10 in various unillustrated formats may be input to the artificial neural network-based parser 111.

The electronic device 100 may preprocess the document 10 before inputting the document 10 to the artificial neural network-based parser 111. For example, the electronic device 100 may convert the size of the document 10 into a size that the artificial neural network-based parser 111 can process, or may correct the resolution and/or distortion of the document 10.

The electronic device 100 may analyze the layout of the document 10 using the artificial neural network-based parser 111. In relation to this, the artificial neural network-based parser 111 may include at least one of a vision language model or a multimodal language model, and the electronic device 100 may analyze the layout of the document 10 using the language model of the artificial neural network-based parser 111. The artificial neural network-based parser 111 may further include at least one model (for example, an object detection model) that is linked with the vision language model and/or the multimodal language model to support the layout analysis of the document 10 by the language model. Alternatively, the artificial neural network-based parser 111 may further include at least one analysis model specialized for layout analysis of the document 10 and operating independently of the vision language model and/or the multimodal language model.

The electronic device 100 may analyze the types of content included in the document 10 as at least part of the operation of analyzing the layout of the document 10. For example, the electronic device 100 may identify a first content 11, 13, and/or 15 of a first type (for example, text) and a second content 17 of a second type (for example, a table and/or a figure) in the document 10 using the language model and/or an analysis model of the artificial neural network-based parser 111. In addition, the electronic device 100 may identify attributes of the content included in the document 10 (for example, a main title 11, a sub-title 13, and/or a body text 15) and/or positions of the content (for example, bounding box coordinates and/or center coordinates of the content) using the language model and/or the analysis model of the artificial neural network-based parser 111 as at least part of the operation of analyzing the layout of the document 10.

The electronic device 100 may obtain first data 20 (for example, text data) from the identified first content of the first type. For example, the electronic device 100 may extract the first data 20 from the document 10 by parsing the first content of the first type using the artificial neural network-based parser 111.

The electronic device 100 may interpret the first data 20 using the language model of the artificial neural network-based parser 111 to identify a domain, intent, and/or parameter related to the first data 20. The electronic device 100 may determine a first context related to the second content 17 of the second type based on the domain, intent, and/or parameter identified for the first data 20 and the positions of the content identified based on the layout analysis of the document 10. In relation to this, the electronic device 100 may identify at least one first content adjacent to the second content 17 in the document 10. For example, the electronic device 100 may identify at least one first content included within a designated distance range from position information (for example, bounding box coordinates and/or center coordinates) corresponding to the second content 17 based on the positions of the content. In addition, the electronic device 100 may identify data that includes information related to the second content 17 or indicates the meaning of the second content 17 among the first data corresponding to each of the identified at least one first content. For example, the electronic device 100 may identify first data corresponding to a caption, a title, and/or a note related to the second content 17. The electronic device 100 may determine at least one first data that is adjacent to the second content 17 in the document 10 and is related to the second content 17 as the first context for the second content 17 of the second type.

The electronic device 100 may convert the second content 17 of the second type into second data 40 (for example, text data) using the artificial neural network-based parser 111. For example, the electronic device 100 may convert the second content 17 into the second data 40 based on a prompt 30 input to the artificial neural network-based parser 111. The prompt 30 may include at least one command related to the generation of the second data 40. For example, the prompt 30 may include a command to interpret data (for example, text, a label, a shape, a line, a color, and/or a cell) included in the second content 17, and to output (or generate) the natural language-based second data 40 including semantic information about the second content 17 using the data and the first context related to the second content 17.

Referring to FIG. 5, as an example of a process of converting a second content 17a of a second type (for example, a table) identified in the document 10 into the second data 40, the electronic device 100 may interpret cells (cell) defined by lines (line) by analyzing the structure of the second content 17a using the language model and/or the analysis model of the artificial neural network-based parser 111. For example, the electronic device 100 may interpret a first cell 16a included in the second content 17a as a title (or index) of a row corresponding to the first cell 16a, and may interpret a second cell 16b as a header (header) of a column corresponding to the second cell 16b. In addition, the electronic device 100 may interpret a third cell 16c related to the first cell 16a and the second cell 16b as an intersection value of the row and the column. Similarly, the electronic device 100 may interpret each of the first cell 16a, a fourth cell 16d, and a fifth cell 16e as a title of a corresponding row, a header of a corresponding column, and an intersection value of the row and the column. The electronic device 100 may generate a first portion 41 of the second data 40, which describes the data of the second content 17a, by describing (or listing) data (for example, text and shapes) included in the interpreted cells as natural language text based on the relationship of the cells, using the language model of the artificial neural network-based parser 111.

The electronic device 100 may generate a second portion 43 of the second data 40 based on the first context determined for the second content 17a. In relation to this, the electronic device 100 may identify first data corresponding to each of at least one first content adjacent to the second content 17a in the document 10 using the language model of the artificial neural network-based parser 111, and among the first data, identify data (for example, a text sentence 12b and/or a text title 14) that includes information related to the second content 17a (for example, a parameter corresponding to a keyword 12a ‘table’ indicating the second content 17a) or indicates the meaning of the second content 17a (for example, ‘main parts for each vehicle model’). The electronic device 100 may generate the second portion 43 of the second data 40, which is natural language text indicating the definition and/or supplementary explanation of the second content 17a, by inferring the definition and/or supplementary explanation of the second content 17a based on the identified first data, using the language model of the artificial neural network-based parser 111.

The electronic device 100 may determine a precedence relationship between the first portion 41 and the second portion 43 in the second data 40 based on the position of the first content (or the first data extracted from the first content) used to determine the first context for the second content 17a. For example, when the first content used to determine the first context of the second content 17a precedes the second content 17a in the document 10, the electronic device 100 may arrange the second portion 43 of the second data 40 generated based on the first content to precede the first portion 41. Alternatively, when the first content used to determine the first context of the second content 17a follows the second content 17a in the document 10, the electronic device 100 may arrange the second portion 43 of the second data 40 generated based on the first content to follow the first portion 41.

Based on what is shown in FIG. 5, the electronic device 100 does not simply parse the second content 17a of the second type or convert the second content 17a into structured data of a designated format (for example, markdown, HTML, and/or JSON), but converts the second content 17a into natural language-based text data indicating semantic information of the second content 17a based on the context related to the second content 17a and the relationship information between the data of the second content 17a, thereby preventing loss of data included in the second content 17a, or supporting intuitive understanding of the second content 17a by the language model 115.

Referring to FIG. 3, the electronic device 100 may generate a final parsing result 50 of the document 10 using the first data 20 extracted from the first content of the document 10 and the second data 40 converted from the second content. In relation to this, the electronic device 100 may determine a second context related to the second content. For example, the electronic device 100 may identify an arrangement relationship between the first content and the second content based on the positions of the content identified according to the layout analysis of the document 10, and may determine a sequence for listing the first data 20 extracted from the first content and the second data 40 converted from the second content according to the arrangement relationship, and determine the sequence as the second context. The electronic device 100 may generate the final parsing result 50 for the document 10, in which the first data 20 and the second data 40 are integrated, by arranging the first data 20 and the second data 40 according to the second context, for example, the determined sequence. Accordingly, the electronic device 100 may parse the document 10 page by page. For example, the electronic device 100 may perform the extraction of the first data 20 and the generation of the second data 40 simultaneously (or in parallel), and may generate the final parsing result 50 for a specific page of the document 10 by combining the first data 20 and the second data 40 (for example, arranging them according to the second context). In other words, the electronic device 100 may generate a single final parsing result 50 in which the first data 20 and the second data 40 are continuously linked for a specific page of the document 10, instead of generating the first data 20 and the second data 40 as separate parsing results from each other.

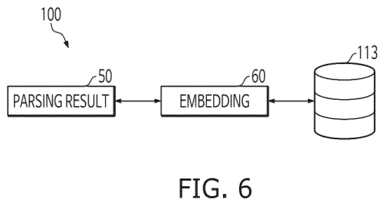

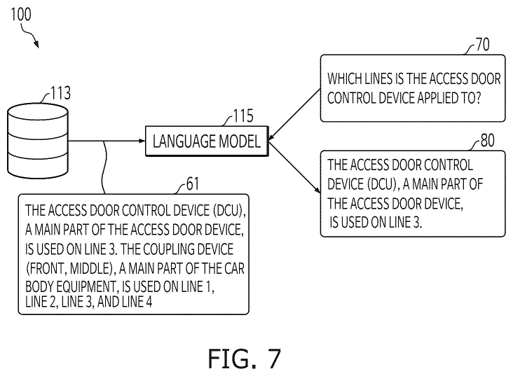

FIG. 6 illustrates a process of storing a parsing result in a database. FIG. 7 illustrates a response process of a language model to a user prompt related to a second content.

Referring to FIG. 6, the electronic device 100 may store the final parsing result 50, which is natural language-based text data generated using the first data 20 extracted from the first content of the document 10 and the second data 40 converted from the second content, in the vector database 113. For example, the electronic device 100 may embed 60 the final parsing result 50 into vector data that the language model 115 can understand, and may store the vector data and the final parsing result 50 corresponding to the vector data in the vector database 113 by associating (or mapping) them.

The electronic device 100 may chunk text data related to the final parsing result 50 into units of words, sentences, paragraphs, documents, and/or a defined number of tokens before embedding 60 the final parsing result 50. In this case, the electronic device 100 may embed the chunked text data, and may store the generated vector data and a portion of the text data corresponding to the generated vector data (for example, data in a chunked unit) in the vector database 113 by associating them.

Referring to FIG. 7, the electronic device 100 may receive a user prompt 70 (or a user query) requesting information related to the second content of the second type (for example, a table and/or a figure) included in the document 10. The electronic device 100 may convert the user prompt 70 into first vector data in response to receiving the user prompt 70. The electronic device 100 may search the vector database 113 for second vector data having a similarity of a designated level or higher with the first vector data using the language model 115, and may obtain at least a portion 61 of the second data, which is natural language text data stored in association (or mapped) with the second vector data. The electronic device 100 may generate answer data 80 based on the at least a portion 61 of the second data using the language model 115, and may provide (or output) the answer data 80 as a response to the user prompt 70.

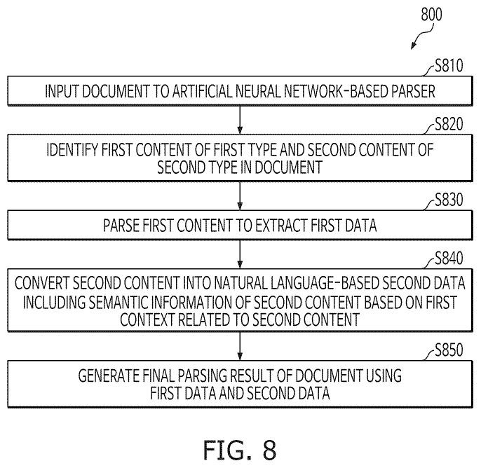

FIG. 8 illustrates a document parsing method.

The steps of a document parsing method 800 as described in FIG. 8 may be performed sequentially or non-sequentially. For example, the execution order of the steps described in FIG. 8 may be changed, some steps may be repeatedly performed, or at least two steps may be performed in parallel. In addition, at least some of the steps described in FIG. 8 may include the same or similar operations as the operations of the electronic device described through the preceding drawings, and redundant descriptions of the same or similar operations may be omitted below.

Referring to FIG. 8, in step S810, the electronic device 100 may input the document 10 to the artificial neural network-based parser 111 (hereinafter, referred to as the artificial neural network-based parser 111). For example, the electronic device 100 may input the document 10 loaded from the memory 110 or the document 10 obtained from an external source (for example, the external electronic device 300) to the artificial neural network-based parser 111. The document 10 input to the artificial neural network-based parser 111 may include at least one of a word processor document in DOC and/or DOCX format, a spreadsheet document in XLS and/or XLSX format, a presentation document in PPT and/or PPTX format, a web document in HTM and/or HTML format, or a PDF document, including at least content of a table and/or figure type.

In step S820, the electronic device 100 may identify the first content of the first type (for example, text) and the second content of the second type (for example, a table and/or a figure) in the document 10 input to the artificial neural network-based parser 111. For example, the electronic device 100 may identify the first content of the first type and the second content of the second type in the document 10 by analyzing the layout of the document 10 using the vision language model, the multimodal language model, and/or at least one analysis model specialized for layout analysis included in the artificial neural network-based parser 111.

In step S830, the electronic device 100 may obtain first data (for example, text data) from the document 10. For example, the electronic device 100 may extract the first data from the document 10 by parsing the first content of the first type using the artificial neural network-based parser 111.

In step S840, the electronic device 100 may convert the second content into natural language-based second data including semantic information based on the first context related to the second content. In relation to this, the electronic device 100 may identify a domain, intent, and/or parameter related to the first data by interpreting the first data extracted from the first content using the artificial neural network-based parser 111, and may determine the first context related to the second content based on the domain, intent, and/or parameter of the first data and the positions of the content identified according to the layout analysis of the document 10. For example, the electronic device 100 may identify at least one first content adjacent to the second content (for example, included within a designated distance range from bounding box coordinates and/or center coordinates corresponding to the second content) based on the positions of the content on the document 10, and may identify data (for example, first data corresponding to a caption, title, and/or note related to the second content) that includes information related to the second content or indicates the meaning of the second content among the first data corresponding to each of the at least one first content. The electronic device 100 may determine at least one first data that is adjacent to the second content in the document 10 and is related to the second content as the first context for the second content.

The electronic device 100 may generate the second data using the determined first context according to a prompt including at least one command related to the generation of the second data (for example, conversion for the second content). For example, the electronic device 100 may generate a first portion of the second data, which is natural language text describing the data included in the second content, using the artificial neural network-based parser 111, and may generate a second portion of the second data, which is natural language text indicating the definition and/or supplementary explanation of the second content, using the first context for the second content.

The electronic device 100 may align the first portion and the second portion of the generated second data based on the position of the first content used to determine the first context for the second content. For example, when the first content used to determine the first context of the second content in the document 10 precedes the second content, the electronic device 100 may arrange the second portion of the second data generated based on the first content to precede the first portion.

In step S840, the electronic device 100 may generate the final parsing result of the document 10 using the first data extracted from the first content of the document 10 and the second data converted from the second content. In this operation, the electronic device 100 may identify the arrangement relationship between the first content and the second content based on the positions of the content identified according to the layout analysis of the document 10, and may determine the sequence for listing the first data and the second data according to the arrangement relationship. The electronic device 100 may determine the determined sequence as the second context related to the second content, and may generate the natural language-based final parsing result by arranging the first data and the second data based on the second context.

According to an aspect of the present disclosure, a method performed by an apparatus comprising at least one processor is provided. The method includes inputting a document to an artificial neural network-based parser. The method includes identifying, in the document and via the artificial neural network-based parser, a first content of a first type and a second content of a second type different from the first type. The method includes parsing, via the artificial neural network-based parser, the first content to extract first data. The method includes converting, based on a first context related to the second content, the second content into natural language-based second data comprising semantic information of the second content. The method includes outputting, based on the first data and the natural language-based second data, a final parsing result of the document.

According to other aspects of the present disclosure, the method may include one or more of the following features. The identifying the first content of the first type and the second content of the second type may include identifying, via the artificial neural network-based parser, a layout of the document. The identifying the first content of the first type and the second content of the second type may include identifying, via the artificial neural network-based parser and based on the identified layout, at least one of a type of content in the document, an attribute of the content in the document, or a position of the content included in the document. The converting the second content into the natural language-based second data may include identifying, based on the position of the content, at least a portion of the first content included within a designated distance range in the document from a position corresponding to the second content. The converting the second content into the natural language-based second data may further include, among at least a portion of the first data corresponding to the first content, identifying, via the artificial neural network-based parser, data related to at least one of a caption, a title, or a note related to the second content. The converting the second content into the natural language-based second data may further include determining the data related to the at least one of the caption, the title, or the note as the first context related to the second content. The converting the second content into the natural language-based second data may further include generating, via the artificial neural network-based parser, a first portion of the natural language-based second data that describes data included in the second content. The converting the second content into the natural language-based second data may further include generating, via the artificial neural network-based parser and based on the data determined as the first context, a second portion of the natural language-based second data that defines the second content or further describes the data included in the second content. The converting the second content into the natural language-based second data may further include determining, via the artificial neural network-based parser, a precedence relationship between the first portion and the second portion of the natural language-based second data, based on at least a portion of the first content corresponding to the data determined as the first context and based on a position of the second content. The converting the second content into the natural language-based second data may further include arranging, based on the precedence relationship, the first portion and the second portion in the natural language-based second data. The outputting the final parsing result of the document may include determining, via the artificial neural network-based parser and based on the position of the content, a second context related to the second content. The determining the second context may include identifying, via the artificial neural network-based parser and based on the position of the content, an arrangement relationship between the first content and the second content. The determining the second context may include determining, based on the arrangement relationship, a sequence for arranging the first data and the natural language-based second data in the final parsing result. The determining the second context may include determining the sequence as the second context related to the second content. The outputting the final parsing result of the document may further include generating, via the artificial neural network-based parser, the final parsing result as natural language-based data in which the first data and the natural language-based second data are integrated, based on the sequence. The document may include at least one of a word processor document, a spreadsheet document, a presentation document, a web document, or a portable document format document. The identifying the first content of the first type and the second content of the second type may include identifying at least one of a table or a figure as the second content of the second type. The method may further include storing the final parsing result in a vector database. The method may further include receiving a prompt related to the second content. The method may further include obtaining, from the vector database and using a language model, at least a portion of the natural language-based second data related to the prompt. The method may further include generating, using the language model and based on the at least a portion of the natural language-based second data, answer data for the prompt. The method may further include training the artificial neural network-based parser by inputting, into the artificial neural network-based parser, at least one parameter of the document and at least one parameter of the final parsing result. The method may further include outputting, based on the trained artificial neural network-based parser, a parsing result of a second document. The artificial neural network-based parser may include at least one of a vision language model, a multimodal language model, or an object detection model.

According to another aspect of the present disclosure, a non-transitory computer-readable medium storing instructions is provided. The instructions, when executed by a computing device, cause the computing device to input a document to an artificial neural network-based parser. The instructions, when executed by the computing device, cause the computing device to identify, in the document and via the artificial neural network-based parser, a first content of a first type and a second content of a second type different from the first type. The instructions, when executed by the computing device, cause the computing device to parse, via the artificial neural network-based parser, the first content to extract first data. The instructions, when executed by the computing device, cause the computing device to convert, based on a first context related to the second content, the second content into natural language-based second data comprising semantic information of the second content. The instructions, when executed by the computing device, cause the computing device to output, based on the first data and the natural language-based second data, a final parsing result of the document.

According to other aspects of the present disclosure, the non-transitory computer-readable medium may include one or more of the following features. The instructions, when executed by the computing device, may cause the computing device to identify the first content of the first type and the second content of the second type by identifying, via the artificial neural network-based parser, a layout of the document. The instructions, when executed by the computing device, may cause the computing device to identify the first content of the first type and the second content of the second type by identifying, via the artificial neural network-based parser and based on the identified layout, at least one of a type of content in the document, an attribute of the content in the document, or a position of the content included in the document. The document may include at least one of a word processor document, a spreadsheet document, a presentation document, a web document, or a portable document format document. The instructions, when executed by the computing device, may cause the computing device to identify the first content of the first type and the second content of the second type by identifying at least one of a table or a figure as the second content of the second type. The instructions, when executed by the computing device, may further cause the computing device to store the final parsing result in a vector database. The instructions, when executed by the computing device, may further cause the computing device to receive a prompt related to the second content. The instructions, when executed by the computing device, may further cause the computing device to obtain, from the vector database and using a language model, at least a portion of the natural language-based second data related to the prompt. The instructions, when executed by the computing device, may further cause the computing device to generate, using the language model and based on the at least a portion of the natural language-based second data, answer data for the prompt. The artificial neural network-based parser may include at least one of a vision language model, a multimodal language model, or an object detection model. The instructions, when executed by the computing device, may further cause the computing device to train the artificial neural network-based parser by inputting, into the artificial neural network-based parser, at least one parameter of the document and at least one parameter of the final parsing result. The instructions, when executed by the computing device, may further cause the computing device to output, based on the trained artificial neural network-based parser, a parsing result of a second document.

According to another aspect of the present disclosure, a computing device is provided. The computing device includes a processor. The computing device includes a memory storing at least one instruction that is configured to be executed by the processor to cause the computing device to input a document to an artificial neural network-based parser. The at least one instruction is configured to be executed by the processor to cause the computing device to identify, in the document and via the artificial neural network-based parser, a first content of a first type and a second content of a second type different from the first type. The at least one instruction is configured to be executed by the processor to cause the computing device to parse, via the artificial neural network-based parser, the first content to extract first data. The at least one instruction is configured to be executed by the processor to cause the computing device to convert, based on a first context related to the second content, the second content into natural language-based second data comprising semantic information of the second content. The at least one instruction is configured to be executed by the processor to cause the computing device to output, based on the first data and the natural language-based second data, a final parsing result of the document.

The above-described method may be provided as a computer program stored in a computer-readable recording medium for execution on a computer. The medium may continuously store the computer-executable program, or temporarily store the program for execution or download. In addition, the medium may be various recording means or storage means in the form of a single hardware or a combination of several hardware devices, and is not limited to a medium directly connected to a certain computer system, but may be distributed on a network. Examples of the medium may include magnetic media such as hard disks, floppy disks, and magnetic tapes, optical recording media such as CD-ROMs and DVDs, magneto-optical media such as floptical disks, and ROM, RAM, flash memory, etc., configured to store program instructions. In addition, other examples of media may include recording media or storage media managed by app stores that distribute applications or sites, servers, etc., that supply or distribute various other software.

The methods, operations, or techniques of the present disclosure may be implemented by various means. For example, these techniques may be implemented in hardware, firmware, software, or a combination thereof. Those of ordinary skill in the art will understand that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design requirements imposed on the overall system. Those of ordinary skill in the art may implement the described functionality in varying ways for each particular application, but such implementation decisions should not be interpreted as causing a departure from the scope of the present disclosure.

In a hardware implementation, the processing units used to perform the techniques may be implemented within one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, a computer, or a combination thereof.

Accordingly, the various illustrative logical blocks, modules, and circuits described in connection with the present disclosure may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In a firmware and/or software implementation, the techniques may be implemented as instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage device, etc. The instructions may be executable by one or more processors, and may cause the processor(s) to perform certain aspects of the functionality described in the present disclosure.

If implemented in software, the techniques described above may be stored on or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium.

For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disks and discs, as used herein, may include a CD, a laser disc, an optical disc, a digital versatile disc (DVD), a floppy disk and/or a Blu-ray disc, where disks usually reproduce data magnetically, while discs reproduce data optically with lasers. Combinations of the above should also be included within the scope of computer-readable media.

A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Although the example embodiment(s) described herein are described as utilizing aspects of the presently disclosed subject matter in one or more standalone computer systems, the present disclosure is not limited thereto, and may be implemented in connection with any computing environment, such as a network or a distributed computing environment. Furthermore, aspects of the subject matter in the present disclosure may be implemented in a plurality of processing chips or devices, and storage may be similarly affected across a plurality of devices. Such devices may include PCs, network servers, and portable devices.

Although the present disclosure has been described in connection with one or more example embodiments, various modifications and changes may be made without departing from the scope of the present disclosure, which can be understood by those of ordinary skill in the art to which the present disclosure pertains. In addition, such modifications and changes should be considered to be within the scope of the claims appended to the present disclosure.

What is claimed is:

1. A method performed by an apparatus comprising at least one processor, the method comprising:
inputting a document to an artificial neural network-based parser;
identifying, in the document and via the artificial neural network-based parser, a first content of a first type and a second content of a second type different from the first type;
parsing, via the artificial neural network-based parser, the first content to extract first data;
converting, based on a first context related to the second content, the second content into natural language-based second data comprising semantic information of the second content; and
outputting, based on the first data and the natural language-based second data, a final parsing result of the document.

2. The method as claimed in claim 1, wherein the identifying the first content of the first type and the second content of the second type comprises:
identifying, via the artificial neural network-based parser, a layout of the document; and
identifying, via the artificial neural network-based parser and based on the identified layout, at least one of a type of content in the document, an attribute of the content in the document, or a position of the content included in the document.

3. The method as claimed in claim 2, wherein the converting the second content into the natural language-based second data comprises: identifying, based on the position of the content, at least a portion, of the first content, included within a designated distance range, in the document, from a position corresponding to the second content.

4. The method as claimed in claim 3, wherein the converting the second content into the natural language-based second data further comprises:
among at least a portion, of the first data, corresponding to the first content, identifying, via the artificial neural network-based parser, data related to at least one of a caption, a title, or a note related to the second content; and
determining the data related to the at least one of the caption, the title, or the note as the first context related to the second content.

5. The method as claimed in claim 4, wherein the converting the second content into the natural language-based second data further comprises:
generating, via the artificial neural network-based parser, a first portion, of the natural language-based second data, that describes data included in the second content; and
generating, via the artificial neural network-based parser and based on the data determined as the first context, a second portion, of the natural language-based second data, that defines the second content or further describes the data included in the second content.

6. The method as claimed in claim 5, wherein the converting the second content into the natural language-based second data further comprises:
determining, via the artificial neural network-based parser, a precedence relationship between the first portion and the second portion of the natural language-based second data, based on at least a portion of the first content corresponding to the data determined as the first context and based on a position of the second content; and
arranging, based on the precedence relationship, the first portion and the second portion in the second data.

7. The ethod as claimed in claim 2, wherein the outputting the final parsing result of the document comprises: determining, via the artificial neural network-based parser and based on the position of the content, a second context related to the second content.

8. The method as claimed in claim 7, wherein the determining the second context comprises:
identifying, via the artificial neural network-based parser and based on the position of the content, an arrangement relationship between the first content and the second content;
determining, based on the arrangement relationship, a sequence for arranging the first data and the natural language-based second data in the final parsing result; and
determining the sequence as the second context related to the second content.

9. The method as claimed in claim 8, wherein the outputting the final parsing result of the document further comprises: generating, via the artificial neural network-based parser, the final parsing result as natural language-based data in which the first data and the second data are integrated, based on the sequence.

10. The method as claimed in claim 1, wherein the document comprising at least one of a word processor document, a spreadsheet document, a presentation document, a web document, or a portable document format (PDF) document.

11. The method as claimed in claim 1, wherein the identifying the first content of the first type and the second content of the second type comprises: identifying at least one of a table or a figure as the second content of the second type.

12. The method as claimed in claim 1, further comprising:
storing the final parsing result in a vector database;
receiving a prompt related to the second content;
obtaining, from the vector database and using a language model, at least a portion, of the second data, related to the prompt; and
generating, using the language model and based on the at least a portion of the second data, answer data for the prompt.

13. The method as claimed in claim 1, further comprising:
training the artificial neural network-based parser by inputting, into the artificial neural network-based parser, at least one parameter of the document and at least one parameter of the final parsing result; and
outputting, based on the trained artificial neural network-based parser, a parsing result of a second document,
wherein the artificial neural network-based parser comprises at least one of: a vision language model, a multimodal language model, or an object detection model.

14. A non-transitory computer-readable medium storing instructions that, when executed by a computing device, cause the computing device to:
input a document to an artificial neural network-based parser;
identify, in the document and via the artificial neural network-based parser, a first content of a first type and a second content of a second type different from the first type;
parse, via the artificial neural network-based parser, the first content to extract first data;
convert, based on a first context related to the second content, the second content into natural language-based second data comprising semantic information of the second content; and
output, based on the first data and the natural language-based second data, a final parsing result of the document.

15. The non-transitory computer-readable medium as claimed in claim 14, wherein the instructions, when executed by the computing device, cause the computing device to identify the first content of the first type and the second content of the second type by:
identifying, via the artificial neural network-based parser, a layout of the document; and
identifying, via the artificial neural network-based parser and based on the identified layout, at least one of a type of content in the document, an attribute of the content in the document, or a position of the content included in the document.

16. The non-transitory computer-readable medium as claimed in claim 14, wherein the document comprising at least one of a word processor document, a spreadsheet document, a presentation document, a web document, or a portable document format (PDF) document.

17. The non-transitory computer-readable medium as claimed in claim 14, wherein the instructions, when executed by the computing device, cause the computing device to identify the first content of the first type and the second content of the second type by: identifying at least one of a table or a figure as the second content of the second type.

18. The non-transitory computer-readable medium as claimed in claim 14, wherein the instructions, when executed by the computing device, further cause the computing device to:
store the final parsing result in a vector database;
receive a prompt related to the second content;
obtain, from the vector database and using a language model, at least a portion, of the second data, related to the prompt; and
generate, using the language model and based on the at least a portion of the second data, answer data for the prompt.

19. The non-transitory computer-readable medium as claimed in claim 14, wherein the artificial neural network-based parser comprises at least one of: a vision language model, a multimodal language model, or an object detection model, and
wherein the instructions, when executed by the computing device, further cause the computing device to:
train the artificial neural network-based parser by inputting, into the artificial neural network-based parser, at least one parameter of the document and at least one parameter of the final parsing result; and
output, based on the trained artificial neural network-based parser, a parsing result of a second document.

20. A computing device comprising:
a processor; and
a memory storing at least one instruction that is configured to be executed by the processor to cause the computing device to:
input a document to an artificial neural network-based parser,
identify, in the document and via the artificial neural network-based parser, a first content of a first type and a second content of a second type different from the first type,
parse, via the artificial neural network-based parser, the first content to extract first data,
convert, based on a first context related to the second content, the second content into natural language-based second data comprising semantic information of the second content, and
output, based on the first data and the natural language-based second data, a final parsing result of the document.
